(19) United States
(12) Patent Application Publication
(10) Pub. No.: US 2022/0055182 A1
(43) Pub. Date: Feb. 24, 2022

(54) MULTIPLE ORIENTATION CAVITIES IN TOOLING FOR ABRASIVES

(71) Applicant: 3M INNOVATIVE PROPERTIES COMPANY, St. Paul, MN (US)

(72) Inventors: Joseph B. Eckel, Vadnais Heights, MN (US); Aaron K. Nienaber, Lake Elmo, MN (US); Thomas J. Nelson, Woodbury, MN (US); Ann M. Hawkins, Lake Elmo, MN (US); Amelia W. Koenig, Minneapolis, MN (US)

(21) Appl. No.: 17/415,784

(22) PCT Filed: Dec. 17, 2019
(86) PCT No.: PCT/IB2019/060929

§ 371 Date: Jun. 18, 2021

Related U.S. Application Data
(60) Provisional application No. 62/781,103, filed on Dec. 18, 2018.

(51) Int. Cl. B24D 3/28; B24D 11/00; B24D 18/00; C09K 3/14

(52) U.S. Cl. CPC B24D 3/28; B24D 11/001; B24D 2203/00; C09K 3/1409; B24D 18/0072

(57) ABSTRACT

Various embodiments disclosed relate to a tooling apparatus and method for providing multiple orientation cavities in tooling for abrasive particles in an abrasive article or structure. An example method includes aligning a plurality of shaped abrasive particles into a pattern, including collecting the plurality of shaped abrasive particles at least partially into cavities arranged on a dispensing surface, where at least one of the cavities is configured to allow for multiple orientations of one of the plurality of shaped abrasive particles. The pattern is transferred to a backing substrate containing a layer of adhesive, and the adhesive is cured.

### BACKGROUND

Abrasive particles and abrasive articles incorporating abrasive particles are used for grinding, abrading or finishing a variety of materials and surfaces in manufacturing processes. The orientation of shaped abrasive particles can have an influence on the abrading properties of an abrasive article. Thus, there is a need in the art for systems, apparatus and methods for producing abrasive articles having multiple orientations of constituent abrasive particles while maintaining desired spacing the abrasive particles.

### SUMMARY OF THE DISCLOSURE

The present disclosure provides systems, apparatus and methods for providing multiple orientation cavities in tooling for abrasive particles in an abrasive article or structure. One aspect of the present subject matter provides a method of making abrasive article. The method includes aligning a plurality of shaped abrasive particles into a pattern, including collecting the plurality of shaped abrasive particles at least partially into cavities arranged on a dispensing surface, where at least one of the cavities is configured to allow for multiple orientations of one of the plurality of shaped abrasive particles. The pattern is transferred to a backing substrate containing a layer of adhesive, and the adhesive is cured.

Another aspect of the present subject matter provides a tooling apparatus for making an abrasive article. The tooling apparatus includes a carrier member having a dispensing surface and a back surface opposite the dispensing surface, where the carrier member has cavities formed therein, where the cavities extend into the carrier member from the dispensing surface toward the back surface. Shaped abrasive particles are removably and at least partially disposed within at least some of the cavities, where at least one of the cavities is configured to allow for multiple orientations of at least one of the shaped abrasive particles.

Advantageously, abrasive articles prepared according to the present disclosure exhibit more consistent abrading performance properties as compared to other abrasive articles.

Additional features and advantages of the present disclosure will be further understood upon consideration of the detailed description as well as the appended claims.

### BRIEF DESCRIPTION OF THE FIGURES

The drawings illustrate generally, by way of example, but not by way of limitation, various embodiments discussed in the present document.

FIGS. 1A-1B are schematic diagrams of shaped abrasive particles having a planar trigonal shape, in accordance with various embodiments.

FIGS. 2A-2E are schematic diagrams of shaped abrasive particles having a tetrahedral shape, in accordance with various embodiments.

FIGS. 3A and 3B are sectional views of coated abrasive articles, in accordance with various embodiments.

FIGS. 4-5 are schematic diagrams of coated abrasive article makers, in accordance with various embodiments.

FIG. 6 is a flow diagram of a method for providing multiple orientation cavities in tooling for abrasive particles, in accordance with various embodiments.

FIGS. 7 and 8A-8D are assorted views of cavities in tooling for abrasive particles, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or“the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein “shaped abrasive particle” means an abrasive particle having a predetermined or non-random shape. One process to make a shaped abrasive particle such as a shaped ceramic abrasive particle includes shaping the precursor ceramic abrasive particle in a mold having a predetermined shape to make ceramic shaped abrasive particles. Ceramic shaped abrasive particles, formed in a mold, are one species in the genus of shaped ceramic abrasive particles. Other processes to make other species of shaped ceramic abrasive particles include extruding the precursor ceramic abrasive particle through an orifice having a predetermined shape, printing the precursor ceramic abrasive particle though an opening in a printing screen having a predetermined shape, or embossing the precursor ceramic abrasive particle into a predetermined shape or pattern. In other examples, the shaped ceramic abrasive particles can be cut from a sheet into individual particles. Examples of suitable cutting methods include mechanical cutting, laser cutting, or water-jet cutting. Non-limiting examples of shaped ceramic abrasive particles include shaped abrasive particles, such as triangular plates, or elongated ceramic rods/filaments. Shaped ceramic abrasive particles are generally homogenous or substantially uniform and maintain their sintered shape without the use of a binder such as an organic or inorganic binder that bonds smaller abrasive particles into an agglomerated structure and excludes abrasive particles obtained by a crushing or comminution process that produces abrasive particles of random size and shape. In many embodiments, the shaped ceramic abrasive particles comprise a homogeneous structure of sintered alpha alumina or consist essentially of sintered alpha alumina.

The present disclosure provides systems, apparatus and methods for providing multiple orientation cavities in tooling for abrasive particles in an abrasive article or structure. One aspect of the present subject matter provides a tooling apparatus for making an abrasive article. The tooling apparatus includes a carrier member having a dispensing surface and a back surface opposite the dispensing surface, where the carrier member has cavities formed therein, where the cavities extend into the carrier member from the dispensing surface toward the back surface. Shaped abrasive particles are removably and at least partially disposed within at least some of the cavities, where at least one of the cavities is configured to allow for multiple orientations of at least one of the shaped abrasive particles.

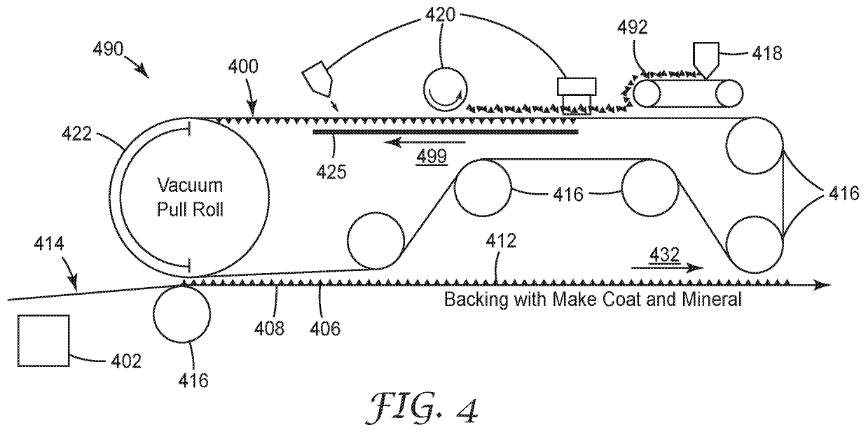

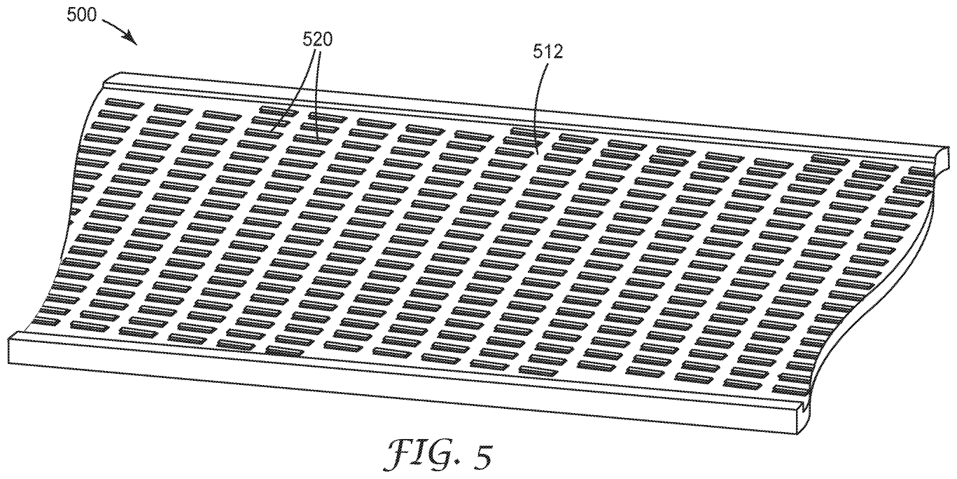

FIGS. 4-5 are schematic diagrams of coated abrasive article makers, in accordance with various embodiments. Referring now to FIG. 4, and FIG. 5, coated abrasive article maker 490 according to the present disclosure includes shaped abrasive particles 492 removably disposed within cavities 520 of production tool 400, 500 having first web path 499 guiding production tool 400, 500 through coated abrasive article maker 490 such that it wraps a portion of an outer circumference of shaped abrasive particle transfer roll 422. Apparatus 490 can include, for example, idler roller 416 and make coat delivery system 402. These components unwind backing 406, deliver make coat resin 408 via make coat delivery system 402 to a make coat applicator and apply make coat resin to first major surface 412 of backing 406. Thereafter resin coated backing 414 is positioned by idler roll 416 for application of shaped abrasive particles 492 to first major surface 412 coated with make coat resin 408. Second web path 432 for resin coated backing 414 passes through coated abrasive article maker apparatus 490 such that resin layer positioned facing the dispensing surface 512 of production tool 400, 500 that is positioned between resin coated backing 414 and the outer circumference of the shaped abrasive particle transfer roll 422. Suitable unwinds, make coat delivery systems, make coat resins, coaters and backings arm known to those of skill in the art. Make coat delivery system 402 can be a simple pan or reservoir containing the make coat resin or a pumping system with a storage tank and delivery plumbing to translate make coat resin 408 to the needed location. Backing 406 can be a cloth, paper, film, nonwoven, scrim, or other web substrate. Make coat applicator 404 can be, for example, a coater, a roll coater, a spray system, a die coater, or a rod coater. Alternatively, a pre-coated backing can be positioned by idler roll 416 for application of shaped abrasive particles 492 to the first major surface.

As shown in FIG. 5, production tool 500 comprises a plurality of cavities 520 having a complimentary shape to intended shaped abrasive particle 492 to be contained therein. Shaped abrasive particle feeder 418 supplies at least some shaped abrasive particles 492 to production tool 400, 500. Shaped abrasive particle feeder 418 can supply an excess of shaped abrasive particles 492 such that there are more shaped abrasive particles 492 present per unit length of production tool in the machine direction than cavities 520 present. Supplying an excess of shaped abrasive particles 492 helps to ensure that a desired amount of cavities 520 within the production tool 400, 500 are eventually filled with shaped abrasive particle 492. Since the bearing area and spacing of shaped abrasive particles 492 is often designed into production tooling 400, 50) for the specific grinding application it is desirable to not have too many unfilled cavities 520. Shaped abrasive particle feeder 418 can be the same width as the production tool 400, 500 and can supply shaped abrasive particles 492 across the entire width of production tool 400, 500. Shaped abrasive particle feeder 418 can be, for example, a vibratory feeder, a hopper, a chute, a silo, a drop coater, or a screw feeder.

Optionally, filling assist member 420 is provided after shaped abrasive particle feeder 418 to move shaped abrasive particles 492 around on the surface of production tool 400, 500 and to help orientate or slide shaped abrasive particles 492 into the cavities 520. Filling assist member 420 can be, for example, a doctor blade, a felt wiper, a brush having a plurality of bristles, a vibration system, a blower or air knife, a vacuum box, or combinations thereof. Filling assist member 420 moves, translates, sucks, or agitates shaped abrasive particles 492 on dispensing surface 512 (top or upper surface of production tool 400 in FIG. 4) to place more shaped abrasive particles 492 into cavities 520. Without filling assist member 420, generally at least some of shaped abrasive particles 492 dropped onto dispensing surface 512 will fall directly into cavity 520 and no further movement is required but others may need some additional movement to be directed into cavity 520. Optionally, filling assist member 420 can be oscillated laterally in the cross machine direction or otherwise have a relative motion such as circular or oval to the surface of production tool 400, 500 using a suitable drive to assist in completely filling each cavity 520 in production tool 400, 500 with a shaped abrasive particle 492. If a brush is used as the filling assist member 420, the bristles may cover a section of dispensing surface 512 from 2-60 inches (5.0-153 cm) in length in the machine direction across all or most all of the width of dispensing surface 512, and lightly rest on or just above dispensing surface 512, and be of a moderate flexibility. Vacuum box 425, if used as filling assist member 420, can be in conjunction with production tool 400, 500 having cavities 520 extending completely through production tool 400, 500. Vacuum box is located near shaped abrasive particle feeder 418 and may be located before or after shaped abrasive particle feeder 418, or encompass any portion of a web span between a pair of idler rolls 416 in the shaped abrasive particle filling and excess removal section of the apparatus. Alternatively, production tool 400, 500 can be supported or pushed on by a shoe or a plate to assist in keeping it planar in this section of the apparatus instead or in addition to vacuum box 425. As shown in FIG. 4, it is possible to include one or more assist members 420 to remove excess shaped abrasive particles 492, in some embodiments it may be possible to include only one assist member 420.

After leaving the shaped abrasive particle filling and excess removal section of apparatus 490, shaped abrasive particles 492 in production tool 400, 500 travel towards resin coated backing 414. Shaped abrasive particle transfer roll 422 is provided and production tooling 400, 500 can wrap at least a portion of the roll's circumference. In some embodiments, production tool 400, 500 wraps between 30 to 180 degrees, or between 90 to 180 degrees of the outer circumference of shaped abrasive particle transfer roll 422. In some embodiments, the speed of the dispensing surface 412 and the speed of the resin layer of resin coated backing 414 are speed matched to each other within ±10 percent, ±5 percent, or ±1 percent, for example.

Various methods can be employed to transfer shaped abrasive particles 492 from cavities 520 of production tool 400, 500 to resin coated backing 414. One method includes a pressure assist method where each cavity 520 in production tooling 400, 500 has two open ends or the back surface or the entire production tooling 400, 500 is suitably porous and shaped abrasive particle transfer roll 422 has a plurality of apertures and an internal pressurized source of air. With pressure assist, production tooling 400, 500 does not need to be inverted but it still may be inverted. Shaped abrasive particle transfer roll 422 can also have movable internal dividers such that the pressurized air can be supplied to a specific arc segment or circumference of the roll to blow shaped abrasive particles 492 out of the cavities and onto resin coated backing 414 at a specific location. In some embodiments, shaped abrasive particle transfer roll 422 may also be provided with an internal source of vacuum without a corresponding pressurized region or in combination with the pressurized region typically prior to the pressurized region as shaped abrasive particle transfer roll 422 rotates. The vacuum source or region can have movable dividers to direct it to a specific region or are segment of shaped abrasive particle transfer roll 422. The vacuum can suck shaped abrasive particles 492 firmly into cavities 520 as the production tooling 400, 500 wraps shaped abrasive particle transfer roll 422 before subjecting shaped abrasive particles 492 to the pressurized region of shaped abrasive particle transfer roll 422. This vacuum region be used, for example, with shaped abrasive particle removal member to remove excess shaped abrasive particles 492 from dispensing surface 512 or may be used to simply ensure shaped abrasive particles 492 do not leave cavities 520 before reaching a specific position along the outer circumference of the shaped abrasive particle transfer roll 422.

After separating from shaped abrasive particle transfer roll 422, production tooling 400, 500 travels along first web path 499 back towards the shaped abrasive particle filling and excess removal section of the apparatus with the assistance of idler rolls 416 as necessary. An optional production tool cleaner can be provided to remove stuck shaped abrasive particles still residing in cavities 520 and/or to remove make coat resin 408 transferred to dispensing surface 512. Choice of the production tool cleaner can depend on the configuration of the production tooling and could be either alone or in combination, an additional air blast, solvent or water spray, solvent or water bath, an ultrasonic horn, or an idler roll the production tooling wraps to use push assist to force shaped abrasive particles 492 out of the cavities 520. Thereafter endless production tooling 520 or belt advances to a shaped abrasive particle filling and excess removal section to be filled with new shaped abrasive particles 492.

Various idler rolls 416 can be used to guide the shaped abrasive particle coated backing 414 having a predetermined, reproducible, non-random pattern of shaped abrasive particles 492 on the first major surface that were applied by shaped abrasive particle transfer roll 422 and held onto the first major surface by the make coat resin along second web path 432 into an oven for curing the make coat resin. Optionally, a second shaped abrasive particle coater can be provided to place additional abrasive particles, such as another type of abrasive particle or diluents, onto the make coat resin prior to entry in an oven. The second abrasive particle coater can be a drop coater, spray coater, or an electrostatic coater as known to those of skill in the art. Thereafter a cured backing with shaped abrasive particles 492 can enter into an optional festoon along second web path 432 prior to further processing such as the addition of a size coat, curing of the size coat, and other processing steps known to those of skill in the art of making coated abrasive articles.

Although maker 490 is shown as including production tool 400, 500 as a belt, it is possible in some alternative embodiments for maker 490 to include production tool 400, 500 on vacuum pull roll 422. For example, vacuum pull roll 422 may include a plurality of cavities 520 to which shaped abrasive particles 492 are directly fed. Shaped abrasive particles 492 can be selectively held in place with a vacuum, which can be disengaged to release shaped abrasive particles 492 on backing 406. Further details on maker 490 and suitable alternative may be found at US 2016/0311081, to 3M Company, St. Paul Minn, the contents of which are hereby incorporated by reference.

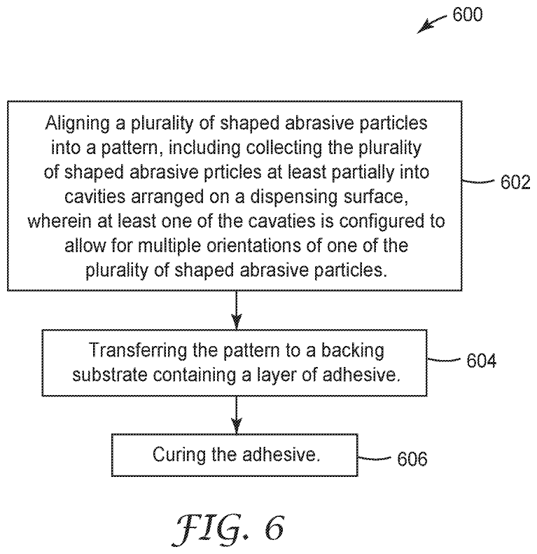

FIG. 6 is a flow diagram of a method for providing multiple orientation cavities in tooling for abrasive particles, in accordance with various embodiments. The method 600 includes aligning a plurality of shaped abrasive particles into a pattern, at 602, including collecting the plurality of shaped abrasive particles at least partially into cavities arranged on a dispensing surface, where at least one of the cavities is configured to allow for multiple orientations of one of the plurality of shaped abrasive particles. The pattern is transferred to a backing substrate containing a layer of adhesive, at 604, and the adhesive is cured, at 606.

In various embodiments, each of the cavities is configured to collect a single particle of the plurality of shaped abrasive particles. At least one of the cavities holds a protruding tip of the one of the shaped abrasive particles is in substantially the same position in each of the multiple orientations, in various embodiments. In one embodiment, the method further includes holding the plurality of shaped abrasive particles at least partially in the cavities using a vacuum source, prior to transferring the pattern to the backing substrate. At least one of the cavities allows for exactly two orientations of the multiple orientations of the one of the plurality of shaped abrasive particles, such as a cross shape, square shape or t-shape in various embodiments. At least one of the cavities allows for 3 to 8 orientations of the multiple orientations of the one of the plurality of shaped abrasive particles, such as an asterisk shape in various embodiments. At least one of the cavities allows for more than 8 orientations of the multiple orientations of the one of the plurality of shaped abrasive particles, and allows for any z-direction orientation of the multiple orientations of the one of the plurality of shaped abrasive particles, such as a cone shape in various embodiments. In one embodiment, at least a majority of the plurality of shaped abrasive particles are shaped as truncated triangular pyramids. In another embodiment, at least one of the shaped abrasive particles of the plurality of shaped abrasive particles comprises a first side and a second side separated by a thickness t, the first side comprises a first face having a triangular perimeter and the second side comprises a second face having a triangular perimeter, wherein the thickness t is equal to or smaller than the length of the shortest side-related dimension of the particle. In various embodiments, the backing substrate is a belt or a disc.

In some embodiments, the tooling apparatus of the present subject matter further includes a vacuum source configured to hold at least some of the shaped abrasive particles at least partially in the cavities, prior to transferring the shaped abrasive articles to a backing substrate containing a layer of adhesive. In various embodiments, at least some of the shaped abrasive particles comprise a ceramic material, alpha alumina, sol-gel derived alpha alumina, or a mixture thereof. At least some of the shaped abrasive particles comprise an aluminosilicate, an alumina, a silica, a silicon nitride, a carbon, a glass, a metal, an alumina-phosphorous pentoxide, an alumina-boria-silica, a zirconia, a zirconia-alumina, a zirconia-silica, a fused aluminum oxide, a heat-treated aluminum oxide, a ceramic aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof, in various embodiments. In some embodiments, at least one of the shaped abrasive particles comprises at least one shape feature comprising: an opening, a concave surface, a convex surface, a groove, a ridge, a fractured surface, a low roundness factor, or a perimeter comprising one or more corner points having a sharp tip. A carrier member of the tooling apparatus comprises a flexible polymer, in various embodiments.

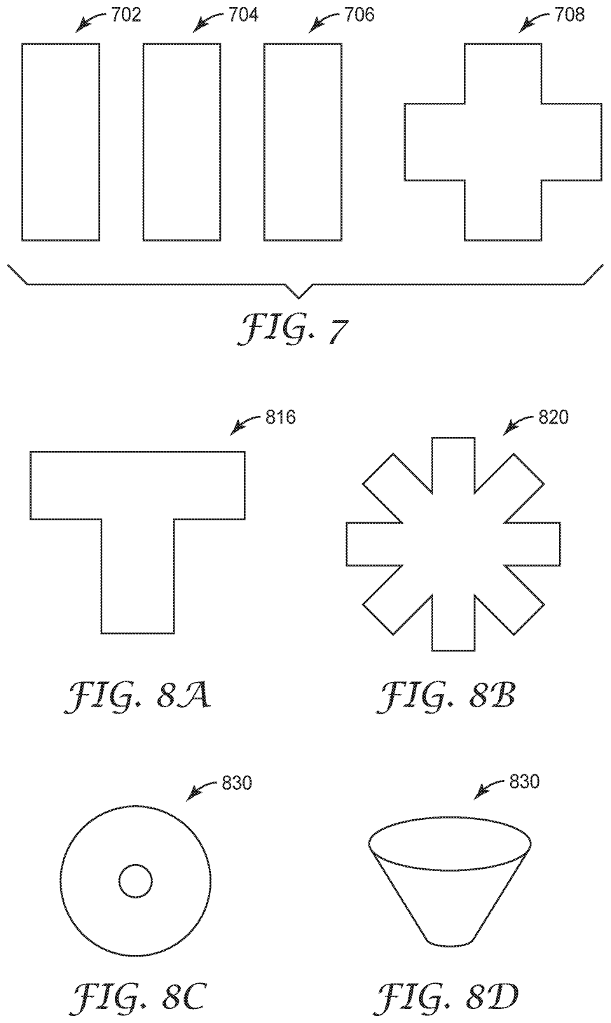

FIGS. 7 and 8A-8D are assorted views of cavities in tooling for abrasive particles, in accordance with various embodiments. In FIG. 7, rectangular cavities 702, 704, 706 allow for a single orientation of a shaped abrasive particle, and cross-shaped cavity 708 allows for exactly two orientations of a shaped abrasive particle, in various embodiments. In FIG. 8A, a t-shaped cavity 816 allows for exactly two orientations of a shaped abrasive particle, in various embodiments. In FIG. 8B, an asterisk-shaped cavity 820 allows for 3 to 8 orientations of a shaped abrasive particle, in various embodiments. FIG. 8C illustrates a top-view of a cone-shaped cavity 830 allowing any orientation (or infinite orientations) of a shaped abrasive particle, and allows for any z-direction orientation the shaped abrasive particle, in various embodiments. FIG. 8D provides a cross-sectional view of cone-shaped cavity 830. An advantage of providing cavities in the tooling is that they can be reused for multiple abrasive articles, saving time and expense when compared to using pockets or indents in the backing of an abrasive article.

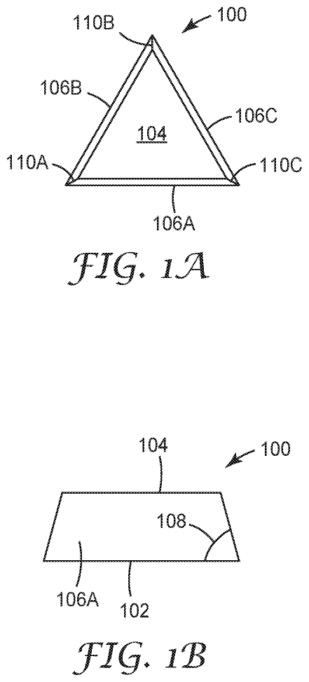

FIGS. 1A and 1B show an example of shaped abrasive particle 100, as an equilateral triangle conforming to a truncated pyramid. As shown in FIGS. 1A and 1B shaped abrasive particle 100 includes a truncated regular triangular pyramid bounded by a triangular base 102, a triangular top 104, and plurality of sloping sides 106A, 106B, 106C connecting triangular base 102 (shown as equilateral although scalene, obtuse, isosceles, and right triangles are possible) and triangular top 104. Slope angle 108A is the dihedral angle formed by the intersection of side 106A with triangular base 102. Similarly, slope angles 108B and 108C (both not shown) correspond to the dihedral angles formed by the respective intersections of sides 106B and 106C with triangular base 102. In the case of shaped abrasive particle 100, all of the slope angles have equal value. In some embodiments, side edges 110A, 110B, and 110C have an average radius of curvature in a range of from about 0.5 μm to about 80 μm, about 10 μm to about 60 μm, or less than, equal to, or greater than about 0.5 μm, 5, 10, 15, 20, 25, 30, 35, 40, 45, 50, 55, 60, 65, 70, 75, or about 80 μm.

In the embodiment shown in FIGS. 1A and 1B, sides 106A, 106B, and 106C have equal dimensions and form dihedral angles with the triangular base 102 of about 82 degrees (corresponding to a slope angle of 82 degrees). However, it will be recognized that other dihedral angles (including 90 degrees) may also be used. For example, the dihedral angle between the base and each of the sides may independently range from 45 to 90 degrees (for example, from 70 to 90 degrees, or from 75 to 85 degrees). Edges connecting sides 106, base 102, and top 104 can have any suitable length. For example, a length of the edges may be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm.

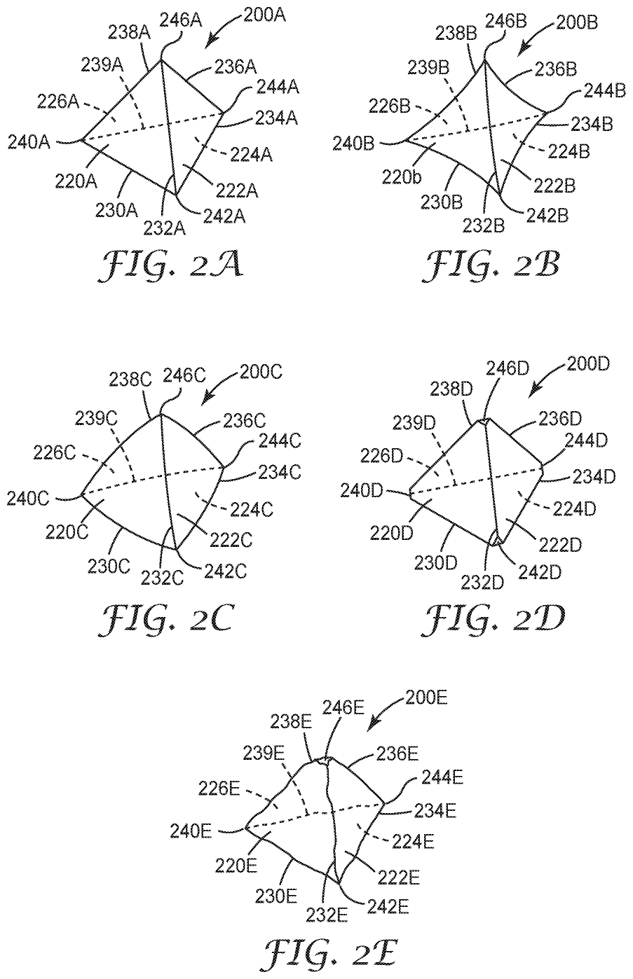

FIGS. 2A-2E are perspective views of the shaped abrasive particles 200 shaped as tetrahedral abrasive particles. As shown in FIGS. 2A-2E, shaped abrasive particles 200 are shaped as regular tetrahedrons. As shown in FIG. 2A, shaped abrasive particle 200A has four faces (220A, 222A, 224A, and 226A) joined by six edges (230A, 232A, 234A, 236A, 238A, and 239A) terminating at four vertices (240A, 242A, 244A, and 246A). Each of the faces contacts the other three of the faces at the edges. While a regular tetrahedron (e.g., having six equal edges and four faces) is depicted in FIG. 2A, it will be recognized that other shapes are also permissible. For example, tetrahedral abrasive particles 200 can be shaped as irregular tetrahedrons (e.g., having edges of differing lengths).

Referring now to FIG. 2B, shaped abrasive particle 200B has four faces (220B, 222B, 224B, and 226B) joined by six edges (230B, 232B, 234B, 236B, 238B, and 239B) terminating at four vertices (240B, 242B, 244B, and 246B). Each of the faces is concave and contacts the other three of the faces at respective common edges. While a particle with tetrahedral symmetry (e.g., four rotational axes of threefold symmetry and six reflective planes of symmetry) is depicted in FIG. 2B, it will be recognized that other shapes are also permissible. For example, shaped abrasive particles 200B can have one, two, or three concave faces with the remainder being planar.

Referring now to FIG. 2C, shaped abrasive particle 200C has four faces (220C, 222C, 224C, and 226C) joined by six edges (230C, 232C, 234C, 236C, 238C, and 239C) terminating at four vertices (240C, 242C, 244C, and 246C). Each of the faces is convex and contacts the other three of the faces at respective common edges. While a particle with tetrahedral symmetry is depicted in FIG. 2C, it will be recognized that other shapes are also permissible. For example, shaped abrasive particles 200C can have one, two, or three convex faces with the remainder being planar or concave.

Referring now to FIG. 2D, shaped abrasive particle 200D has four faces (220D, 222D, 224D, and 226D) joined by six edges (230D, 232D, 234D, 236D, 238D, and 239D) terminating at four truncated vertices (240D, 242D, 244D, and 246D). While a particle with tetrahedral symmetry is depicted in FIG. 2D, it will be recognized that other shapes are also permissible. For example, shaped abrasive particles 200D can have one, two, or three convex faces with the remainder being planar.

Deviations from the depictions in FIGS. 2A-2D can be present. An example of such a shaped abrasive particle 200 is depicted in FIG. 2E, showing shaped abrasive particle 200E, which has four faces (220E, 222E, 224E, and 226E) joined by six edges (230E, 232E, 234E, 236E, 238E, and 239E) terminating at four vertices (240E, 242E, 244E, and 246E). Each of the faces contacts the other three of the faces at respective common edges. Each of the faces, edges, and vertices has an irregular shape.

In any of shaped abrasive particles 200A-200E, the edges can have the same length or different lengths. The length of any of the edges can be any suitable length. As an example, the length of the edges can be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm, shaped abrasive particles 200A-200E can be the same size or different sizes.

Any of shaped abrasive particles 100 or 200 can include any number of shape features. The shape features can help to improve the cutting performance of any of shaped abrasive particles 100 or 200. Examples of suitable shape features include an opening, a concave surface, a convex surface, a groove, a ridge, a fractured surface, a low roundness factor, or a perimeter comprising one or more corner points having a sharp tip. Individual shaped abrasive particles can include any one or more of these features.

Any of shaped abrasive particles 100 or 200 can include the same material or include different materials.

Shaped abrasive particle 100 or 200 can be formed in many suitable manners for example, the shaped abrasive particle 100 or 200 can be made according to a multi-operation process. The process can be carried out using any material or precursor dispersion material. Briefly, for embodiments where shaped abrasive particles 100 or 200 are monolithic ceramic particles, the process can include the operations of making either a seeded or non-seeded precursor dispersion that can be converted into a corresponding (e.g., a boehmite sol-gel that can be converted to alpha alumina); filling one or more mold cavities having the desired outer shape of shaped abrasive particle 100 with a precursor dispersion; drying the precursor dispersion to form precursor shaped abrasive particle; removing the precursor shaped abrasive particle 100 from the mold cavities; calcining the precursor shaped abrasive particle 100 to form calcined, precursor shaped abrasive particle 100 or 200; and then sintering the calcined, precursor shaped abrasive particle 100 or 200 to form shaped abrasive particle 100 or 200. The process will now be described in greater detail in the context of alpha-alumina-containing shaped abrasive particle 100 or 200. In other embodiments, the mold cavities may be filled with a melamine to form melamine shaped abrasive particles.

The process can include the operation of providing either a seeded or non-seeded dispersion of a precursor that can be converted into ceramic. In examples where the precursor is seeded, the precursor can be seeded with an oxide of an iron. The precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the precursor dispersion in some embodiments contains from 30 percent to 50 percent, or 40 percent to 50 percent solids by weight.

Examples of suitable precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area.

The physical properties of the resulting shaped abrasive particle 100 or 200 can generally depend upon the type of material used in the precursor dispersion. As used herein, a “gel” is a three-dimensional network of solids dispersed in a liquid.

The precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of an oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the precursor dispersion can be varied.

The introduction of a modifying additive or precursor of a modifying additive can cause the precursor dispersion to gel. The precursor dispersion can also be induced to gel by application of heat over a period of time to reduce the liquid content in the dispersion through evaporation. The precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the precursor dispersion to produce a more stable hydrosol or colloidal precursor dispersion. Suitable peptizing agents are monoprotic acids or acid compounds such as acetic acid, hydrochloric acid, formic acid, and nitric acid. Multiprotic acids can also be used, but they can rapidly gel the precursor dispersion, making it difficult to handle or to introduce additional components. Some commercial sources of boehmite contain an acid titer (such as absorbed formic or nitric acid) that will assist in forming a stable precursor dispersion.

The precursor dispersion can be formed by any suitable means; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

A further operation can include providing a mold having at least one mold cavity, or a plurality of cavities formed in at least one major surface of the mold. In some examples, the mold is formed as a production tool, which can be, for example, a belt, a sheet, a continuous web, a coating roll such as a rotogravure roll, a sleeve mounted on a coating roll, or a die. In one example, the production tool can include polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one example, the entire tooling is made from a polymeric or thermoplastic material. In another example, the surfaces of the tooling in contact with the precursor dispersion while the precursor dispersion is drying, such as the surfaces of the plurality of cavities, include polymeric or thermoplastic materials, and other portions of the tooling can be made from other materials. A suitable polymeric coating can be applied to a metal tooling to change its surface tension properties, by way of example.

A polymeric or thermoplastic production tool can be replicated off a metal master tool. The master tool can have the inverse pattern of that desired for the production tool. The master tool can be made in the same manner as the production tool. In one example, the master tool is made out of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities can be from an opening in the top surface or bottom surface of the mold. In some examples, the cavities can extend for the entire thickness of the mold. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make shaped abrasive particle 100. The depth dimension is equal to the perpendicular distance from the top surface to the lowermost point on the bottom surface. The depth of a given cavity can be uniform or can vary along its length and/or width. The cavities of a given mold can be of the same shape or of different shapes.

A further operation involves filling the cavities in the mold with the precursor dispersion (e.g., by a conventional technique). In some examples, a knife roll coater or vacuum slot die coater can be used. A mold release agent can be used to aid in removing the particles from the mold if desired. Examples of mold release agents include oils such as peanut oil or mineral oil, fish oil, silicones, polytetrafluoroethylene, zinc stearate, and graphite. In general, a mold release agent such as peanut oil, in a liquid, such as water or alcohol, is applied to the surfaces of the production tooling in contact with the precursor dispersion such that from about 0.1 mg/in² (0.6 mg/cm²) to about 3.0 mg/in² (20 mg/cm²), or from about 0.1 mg/in² (0.6 mg/cm²) to about 5.0 mg/in² (30 mg/cm²), of the mold release agent is present per unit area of the mold when a mold release is desired. In some embodiments, the top surface of the mold is coated with the precursor dispersion. The precursor dispersion can be pumped onto the top surface.

In a further operation, a scraper or leveler bar can be used to force the precursor dispersion fully into the cavity of the mold. The remaining portion of the precursor dispersion that does not enter the cavity can be removed from the top surface of the mold and recycled. In some examples, a small portion of the precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the precursor dispersion extends substantially beyond the top surface.

In those examples where it is desired to have the exposed surfaces of the cavities result in planar faces of the shaped abrasive particles, it can be desirable to overfill the cavities (e.g., using a micronozzle array) and slowly dry the precursor dispersion.

A further operation involves removing the volatile component to dry the dispersion. The volatile component can be removed by fast evaporation rates. In some examples, removal of the volatile component by evaporation occurs at temperatures above the boiling point of the volatile component. An upper limit to the drying temperature often depends on the material the mold is made from. For polypropylene tooling, the temperature should be less than the melting point of the plastic. In one example, for a water dispersion of from about 40 to 50 percent solids and a polypropylene mold, the drying temperatures can be from about 90° C. to about 165° C., or from about 105° C. to about 150° C., or from about 105° C. to about 120° C. Higher temperatures can lead to improved production speeds but can also lead to degradation of the polypropylene tooling, limiting its useful life as a mold.

During drying, the precursor dispersion shrinks, often causing retraction from the cavity walls. For example, if the cavities have planar walls, then the resulting shaped abrasive particle 100 can tend to have at least three concave major sides. It is presently discovered that by making the cavity walls concave (whereby the cavity volume is increased) it is possible to obtain shaped abrasive particle 100 that have at least three substantially planar major sides. The degree of concavity generally depends on the solids content of the precursor dispersion.

A further operation involves removing resultant precursor shaped abrasive particle 100 from the mold cavities. The precursor shaped abrasive particle 100 or 200 can be removed from the cavities by using the following processes alone or in combination on the mold: gravity, vibration, ultrasonic vibration, vacuum, or pressurized air to remove the particles from the mold cavities.

The precursor shaped abrasive particle 100 or 200 can be further dried outside of the mold. If the precursor dispersion is dried to the desired level in the mold, this additional drying step is not necessary. However, in some instances it can be economical to employ this additional drying step to minimize the time that the precursor dispersion resides in the mold. The precursor shaped abrasive particle 100 or 200 will be dried from 10 to 480 minutes, or from 120 to 400 minutes, at a temperature from 50° C. to 160° C., or 120° C. to 150° C.

A further operation involves calcining the precursor shaped abrasive particle 100 or 200. During calcining, essentially all the volatile material is removed, and the various components that were present in the precursor dispersion are transformed into metal oxides. The precursor shaped abrasive particle 100 or 200 is generally heated to a temperature from 400° C. to 800° C. and maintained within this temperature range until the free water and over 90 percent by weight of any bound volatile material are removed. In an optional step, it can be desirable to introduce the modifying additive by an impregnation process. A water-soluble salt can be introduced by impregnation into the pores of the calcined, precursor shaped abrasive particle 100. Then the precursor shaped abrasive particle 100 are pre-fired again.

A further operation can involve sintering the calcined, precursor shaped abrasive particle 100 or 200 to form particles 100 or 200. In some examples where the precursor includes rare earth metals, however, sintering may not be necessary. Prior to sintering, the calcined, precursor shaped abrasive particle 100 or 200 are not completely densified and thus lack the desired hardness to be used as shaped abrasive particle 100 or 200. Sintering takes place by heating the calcined, precursor shaped abrasive particle 100 or 200 to a temperature of from 10000° C. to 1650° C. The length of time for which the calcined, precursor shaped abrasive particle 100 or 200 can be exposed to the sintering temperature to achieve this level of conversion depends upon various factors, but from five seconds to 48 hours is possible.

In another embodiment, the duration of the sintering step ranges from one minute to 90 minutes. After sintering, the shaped abrasive particle 14 can have a Vickers hardness of 10 GPa (gigaPascals), 16 GPa, 18 GPa, 20 GPa, or greater.

Additional operations can be used to modify the described process, such as, for example, rapidly heating the material from the calcining temperature to the sintering temperature, and centrifuging the precursor dispersion to remove sludge and/or waste. Moreover, the process can be modified by combining two or more of the process steps if desired.

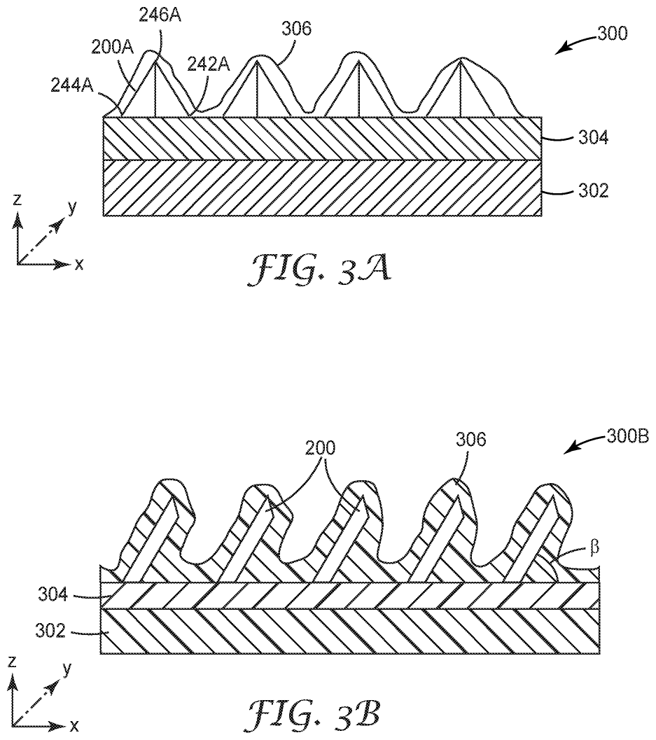

FIG. 3A is a sectional view of coated abrasive article 300. Coated abrasive article 300 includes backing 302 defining a surface along an x-y direction. Backing 302 has a first layer of binder, hereinafter referred to as make coat 304, applied over a first surface of backing 302. Attached or partially embedded in make coat 304 are a plurality of shaped abrasive particles 200A. Although shaped abrasive particles 200A are shown any other shaped abrasive particle described herein can be included in coated abrasive article 300. An optional second layer of binder, hereinafter referred to as size coat 306, is dispersed over shaped abrasive particles 200A. As shown, a major portion of shaped abrasive particles 200A have at least one of three vertices (240, 242, and 244) oriented in substantially the same direction. Tus, shaped abrasive particles 200A are oriented according to a non-random distribution, although in other embodiments any of shaped abrasive particles 200A can be randomly oriented on backing 302. In some embodiments, control of a particle's orientation can increase the cut of the abrasive article.

Backing 302 can be flexible or rigid. Examples of suitable materials for forming a flexible backing include a polymeric film, a metal foil, a woven fabric, a knitted fabric, paper, vulcanized fiber, a staple fiber, a continuous fiber, a nonwoven, a foam, a screen, a laminate, and combinations thereof. Backing 302 can be shaped to allow coated abrasive article 300 to be in the form of sheets, discs, belts, pads, or rolls. In some embodiments, backing 302 can be sufficiently flexible to allow coated abrasive article 300 to be formed into a loop to make an abrasive belt that can be run on suitable grinding equipment.

Make coat 304 secures shaped abrasive particles 200A to backing 302, and size coat 306 can help to reinforce shaped abrasive particles 200A. Make coat 304 and/or size coat 306 can include a resinous adhesive. The resinous adhesive can include one or more resins chosen from a phenolic resin, an epoxy resin, a urea-formaldehyde resin, an acrylate resin, an aminoplast resin, a melamine resin, an acrylated epoxy resin, a urethane resin, a polyester resin, a dying oil, and mixtures thereof.

FIG. 3B shows an example of coated abrasive article 300B, which includes shaped abrasive particles 200 instead of shaped abrasive particles 300. As shown, shaped abrasive particles 200 are attached to backing 302 by make coat 304 with size coat 306 applied to further attach or adhere shaped abrasive particles 200 to the backing 302. As shown in FIG. 3B, the majority of the shaped abrasive particles 200 are tipped or leaning to one side. This results in the majority of shaped abrasive particles 200 having an orientation angle β less than 90 degrees relative to backing 302.

The conventional abrasive particles can, for example, have an average diameter ranging from about 10 μm to about 2000 μm, about 20 μm to about 1300 μm, about 50 μm to about 1000 μm, less than, equal to, or greater than about 10 μm, 20, 30, 40, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1650, 1700, 1750, 1800, 1850, 1900, 1950, or 2000 μm. For example, the conventional abrasive particles can have an abrasives industry-specified nominal grade. Such abrasives industry-accepted grading standards include those known as the American National Standards Institute, Inc. (ANSI) standards, Federation of European Producers of Abrasive Products (FEPA) standards, and Japanese Industrial Standard (HS) standards. Exemplary ANSI grade designations (e.g., specified nominal grades) include: ANSI 12 (1842 μm), ANSI 16 (1320 μm), ANSI 20 (905 μm), ANSI 24 (728 μm), ANSI 36 (530 μm), ANSI 40 (420 μm), ANSI 50 (351 μm), ANSI 60 (264 μm), ANSI 80 (195 μm), ANSI 100 (141 μm), ANSI 120 (116 μm), ANSI 150 (93 μm), ANSI 180 (78 μm), ANSI 220 (66 μm), ANSI 240 (53 μm), ANSI 280 (44 μm), ANSI 320 (46 μm), ANSI 360 (30 μm), ANSI 400 (24 μm), and ANSI 600 (16 μm). Exemplary FEPA grade designations include P12 (1746 μm), P16 (1320 μm), P20 (984 μm), P24 (728 μm), P30 (630 μm), P36 (530 μm), P40 (420 μm), P50 (326 μm), P60 (264 μm), P80 (195 μm), P100 (156 μm), P120 (127 μm), P120 (127 μm), P150 (97 μm), P180 (78 μm), P220 (66 μm), P240 (60 μm), P280 (53 μm), P320 (46 μm), P360 (41 μm), P400 (36 μm), P500 (30 μm), P600 (26 μm), and P800 (22 μm). An approximate average particles size of reach grade is listed in parenthesis following each grade designation.

Shaped abrasive particles 100 or 200 or crushed abrasive particles can include any suitable material or mixture of materials. For example, shaped abrasive particles 100 can include a material chosen from an alpha-alumina, a fused aluminum oxide, a heat-treated aluminum oxide, a ceramic aluminum oxide, a sintered aluminum oxide, a silicon carbide, a titanium diboride, a boron carbide, a tungsten carbide, a titanium carbide, a diamond, a cubic boron nitride, a garnet, a fused alumina-zirconia, a sol-gel derived abrasive particle, a cerium oxide, a zirconium oxide, a titanium oxide, and combinations thereof. In some embodiments, shaped abrasive particles 100 or 200 and crushed abrasive particles can include the same materials. In further embodiments, shaped abrasive particles 100 or 200 and crushed abrasive particles can include different materials.

Filler particles can also be included in abrasive articles 200 or 300. Examples of useful fillers include metal carbonates (such as calcium carbonate, calcium magnesium carbonate, sodium carbonate, magnesium carbonate), silica (such as quartz, glass beads, glass bubbles and glass fibers), silicates (such as talc, clays, montmorillonite, feldspar, mica, calcium silicate, calcium metasilicate, sodium aluminosilicate, sodium silicate), metal sulfates (such as calcium sulfate, barium sulfate, sodium sulfate, aluminum sodium sulfate, aluminum sulfate), gypsum, vermiculite, sugar, wood flour, a hydrated aluminum compound, carbon black, metal oxides (such as calcium oxide, aluminum oxide, tin oxide, titanium dioxide), metal sulfites (such as calcium sulfite), thermoplastic particles (such as polycarbonate, polyetherimide, polyester, polyethylene, poly(vinylchloride), polysulfone, polystyrene, acrylonitrile-butadiene-styrene block copolymer, polypropylene, acetal polymers, polyurethanes, nylon particles) and thermosetting particles (such as phenolic bubbles, phenolic beads, polyurethane foam particles and the like). The filler may also be a salt such as a halide salt. Examples of halide salts include sodium chloride, potassium cryolite, sodium cryolite, ammonium cryolite, potassium tetrafluoroborate, sodium tetrafluoroborate, silicon fluorides, potassium chloride, magnesium chloride. Examples of metal fillers include, tin, lead, bismuth, cobalt, antimony, cadmium, iron and titanium. Other miscellaneous fillers include sulfur, organic sulfur compounds, graphite, lithium stearate and metallic sulfides. In some embodiments, individual shaped abrasive particles 100 or individual crushed abrasive particles can be at least partially coated with an amorphous, ceramic, or organic coating. Examples of suitable components of the coatings include, a silane, glass, iron oxide, aluminum oxide, or combinations thereof. Coatings such as these can aid in processability and bonding of the particles to a resin of a binder.

Some shaped abrasive particles can include a polymeric material and can be characterized as soft abrasive particles. The soft shaped abrasive particles described herein can independently include any suitable material or combination of materials. For example, the soft shaped abrasive particles can include a reaction product of a polymerizable mixture including one or more polymerizable resins. The one or more polymerizable resins such as a hydrocarbyl polymerizable resin. Examples of such resins include those chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, a drying oil, or mixtures thereof. The polymerizable mixture can include additional components such as a plasticizer, an acid catalyst, a cross-linker, a surfactant, a mild-abrasive, a pigment, a catalyst and an antibacterial agent.

Where multiple components are present in the polymerizable mixture, those components can account for any suitable weight percentage of the mixture. For example, the polymerizable resin or resins, may be in a range of from about 35 wt % to about 99.9 wt % of the polymerizable mixture, about 40 wt % to about 95 wt %, or less than, equal to, or greater than about 35 wt %, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99.9 wt %.

If present, the cross-linker may be in a range of from about 2 wt % to about 60 wt % of the polymerizable mixture, from about 5 wt % to about 10 wt %, or less than, equal to, or greater than about 2 wt %, 3, 4, 5, 6, 7, 8, 9, 10, 11, 12, 13, 14, or about 15 wt %. Examples of suitable cross-linkers include a cross-linker available under the trade designation CYMEL 303 LF, of Allnex USA Inc., Alpharetta, Ga., USA; or a cross-linker available under the trade designation CYMEL 385, of Allnex USA Inc., Alpharetta, Ga., USA.

If present, the mild-abrasive may be in a range of from about 5 wt % to about 65 wt % of the polymerizable mixture, about 10 wt % to about 20 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or about 65 wt %. Examples of suitable mild-abrasives include a mild-abrasive available under the trade designation MINSTRON 353 TALC, of Imerys Talc America, Inc., Three Forks, Mont., USA; a mild-abrasive available under the trade designation USG TERRA ALBA NO. 1 CALCIUM SULFATE, of USG Corporation, Chicago, Ill., USA; Recycled Glass (40-70 Grit) available from ESCA Industries, Ltd., Hatfield, Pa., USA, silica, calcite, nepheline, syenite, calcium carbonate, or mixtures thereof.

If present, the plasticizer may be in a range of from about 5 wt % to about 40 wt % of the polymerizable mixture, about 10 wt % to about 15 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or about 40 wt %. Examples of suitable plasticizers include acrylic resins or styrene butadiene resins. Examples of acrylic resins include an acrylic resin available under the trade designation RHOPLEX GL-618, of DOW Chemical Company, Midland, Mich., USA; an acrylic resin available under the trade designation HYCAR 2679, of the Lubrizol Corporation, Wickliffe, Ohio, USA; an acrylic resin available under the trade designation HYCAR 26796, of the Lubrizol Corporation, Wickliffe, Ohio, USA; a polyether polyol available under the trade designation ARCOL LG-650, of DOW Chemical Company, Midland, Mich., USA; or an acrylic resin available under the trade designation HYCAR 26315, of the Lubrizol Corporation, Wickliffe, Ohio, USA. An example of a styrene butadiene resin includes a resin available under the trade designation ROVENE 5900, of Mallard Creek Polymers, Inc., Charlotte, N.C., USA.

If present, the acid catalyst may be in a range of from 0.5 wt % to about 20 wt % of the polymerizable mixture, about 5 wt % to about 10 wt %, or less than, equal to, or greater than about 1 wt %, 2, 3, 4, 5, 6, 7, 8, 9, 10, 11, 12, 13, 14, 15, 16, 17, 18, 19, or about 20 wt %. Examples of suitable acid catalysts include a solution of aluminum chloride or a solution of ammonium chloride.

If present, the surfactant can be in a range of from about 0.001 wt % to about 15 wt % of the polymerizable mixture about 5 wt % to about 10 wt %, less than, equal to, or greater than about 0.001 wt %, 0.01, 0.5, 1, 2, 3, 4, 5, 6, 7, 8, 9, 10, 11, 12, 13, 14, or about 15 wt %. Examples of suitable surfactants include a surfactant available under the trade designation GEMTEX SC-85-P, of Innospec Performance Chemicals, Salisbury, N.C., USA; a surfactant available under the trade designation DYNOL 604, of Air Products and Chemicals, Inc., Allentown, Pa., USA; a surfactant available under the trade designation ACRYSOL RM-8W, of DOW Chemical Company, Midland, Mich., USA; or a surfactant available under the trade designation XIAMETER AFE 1520, of DOW Chemical Company, Midland, Mich., USA.

If present, the antimicrobial agent may be in a range of from 0.5 wt % to about 20 wt % of the polymerizable mixture, about 10 wt % to about 15 wt %, or less than, equal to, or greater than about 0.5 wt %, 1, 2, 3, 4, 5, 6, 7, 8, 9, 10, 11, 12, 13, 14, 15, 16, 17, 18, 19, or about 20 wt %. An example of a suitable antimicrobial agent includes zinc pyrithione.

If present, the pigment may be in a range of from about 0.1 wt % to about 10 wt % of the polymerizable mixture, about 3 wt % to about 5 wt %, less than, equal to, or greater than about 0.1 wt %, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, or about 10 wt %. Examples of suitable pigments include a pigment dispersion available under the trade designation SUNSPERSE BLUE 15, of Sun Chemical Corporation, Parsippany, N.J., USA; a pigment dispersion available under the trade designation SUNSPERSE VIOLET 23, of Sun Chemical Corporation, Parsippany, N.J., USA; a pigment dispersion available under the trade designation SUN BLACK, of Sun Chemical Corporation, Parsippany, N.J., USA; or a pigment dispersion available under the trade designation BLUE PIGMENT B2G, of Clariant Ltd., Charlotte, N.C., USA. The mixture of components can be polymerized by curing.

The specific z-direction rotational orientation of formed abrasive particles can be achieved through use of cavities that position shaped abrasive particles 100 or 200 into a specific z-direction rotational orientation such that shaped abrasive particle 100 or 200 can only fit into the cavities in a few specific orientations such as less than or equal to 4, 3, 2, or 1 orientations. For example, a rectangular opening just slightly bigger than the cross section of shaped abrasive particle 100 or 200 comprising a rectangular plate will orient shaped abrasive particle 100 or 200 in one of two possible 180 degree opposed z-direction rotational orientations. The cavities can be designed such that shaped abrasive particles 100 or 200, while positioned in the cavities, can rotate about their z-axis (normal to the screen's surface when the formed abrasive particles are positioned in the aperture) less than or equal to about 30, 20, 10, 5, 2, or 1 angular degrees.

The precision apertured screen having a plurality of apertures selected to z-directionally orient shaped abrasive particles 100 and 200 into a pattern, can have a retaining member such as adhesive tape on a second precision apertured screen with a matching aperture pattern, an electrostatic field used to hold the particles in the first precision screen or a mechanical lock such as two precision apertured screens with matching aperture patterns twisted in opposite directions to pinch particles 100 and 200 within the apertures. The first precision aperture screen is filled with shaped abrasive particles 100 and 200, and the retaining member is used to hold shaped abrasive particles 100 in place in the apertures. In one embodiment, adhesive tape on the surface of a second precision aperture screen aligned in a stack with the first precision aperture screen causes shaped abrasive particles 100 to stay in the apertures of the first precision screen stuck to the surface of the tape exposed in the second precision aperture screen's apertures.

Other methods of making an abrasive article could also be used, for examples, methods according to the disclosure in U.S. Patent Application Nos. 62/781,021, and 62/825,938.

In this document, the terms “a,” “an,” or“the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Select embodiments of the present disclosure include, but are not limited to, the following:

In a first embodiment, the present disclosure provides a method of making an abrasive article, the method comprising:

aligning a plurality of shaped abrasive particles into a pattern, including collecting the plurality of shaped abrasive particles at least partially into cavities arranged on a dispensing surface, wherein at least one of the cavities is configured to allow for multiple orientations of at least one of the plurality of shaped abrasive particles;

transferring the pattern to a backing substrate containing a layer of adhesive; and

curing the adhesive.

In a second embodiment, the present disclosure provides a method of making an abrasive article according to the first embodiment, wherein each of the cavities is configured to collect a single particle of the plurality of shaped abrasive particles.

In a third embodiment, the present disclosure provides a method of making an abrasive article according to any one of the first and second embodiments, wherein the at least one of the cavities holds a protruding tip of the one of the shaped abrasive particles in substantially the same position in each of the multiple orientations.

In a fourth embodiment, the present disclosure provides a method of making an abrasive article according to any one of the first through third embodiments, further comprising holding the plurality of shaped abrasive particles at least partially in the cavities using a vacuum source, prior to transferring the pattern to the backing substrate.

In a fifth embodiment, the present disclosure provides a method of making an abrasive article according to any one of the first through fourth embodiments, wherein the at least one of the cavities allows for exactly two orientations of the multiple orientations of the one of the plurality of shaped abrasive particles.

In a sixth embodiment, the present disclosure provides a method of making an abrasive article according to the fifth embodiment, wherein the at least one of the cavities includes a cross shape.

In a seventh embodiment, the present disclosure provides a method of making an abrasive article according to the fifth embodiment, wherein the at least one of the cavities includes a square shape.

In an eighth embodiment, the present disclosure provides a method of making an abrasive article according to any one of the first through fourth embodiments, wherein the at least one of the cavities allows for 3 to 8 orientations of the multiple orientations of the one of the plurality of shaped abrasive particles.

In a ninth embodiment, the present disclosure provides a method of making an abrasive article according to the eighth embodiment, wherein the at least one of the cavities includes an asterisk shape.

In a tenth embodiment, the present disclosure provides a method of making an abrasive article according to any one of the first through fourth embodiments, wherein the at least one of the cavities allows for more than 8 orientations of the multiple orientations of the one of the plurality of shaped abrasive particles.

In an eleventh embodiment, the present disclosure provides a method of making an abrasive article according to any one of the first through fourth embodiments, wherein the at least one of the cavities allows for any z-direction orientation of the multiple orientations of the one of the plurality of shaped abrasive particles.

In a twelfth embodiment, the present disclosure provides a method of making an abrasive article according to any one of the tenth and eleventh embodiments, wherein the at least one of the cavities includes a cone shape.

In a thirteenth embodiment, the present disclosure provides a method of making an abrasive article according to any one of the first through twelfth embodiments, wherein at least a majority of the plurality of shaped abrasive particles are shaped as truncated triangular pyramids.

In a fourteenth embodiment, the present disclosure provides a method of making an abrasive article according to any one of the first through thirteenth embodiments, wherein at least one of the shaped abrasive particles of the plurality of shaped abrasive particles comprises a first side and a second side separated by a thickness t, the first side comprises a first face having a triangular perimeter and the second side comprises a second face having a triangular perimeter, wherein the thickness t is equal to or smaller than the length of the shortest side-related dimension of the particle.

In a fifteenth embodiment, the present disclosure provides a method of making an abrasive article according to any one of the first through fourteenth embodiments, wherein the backing substrate is a belt.

In a sixteenth embodiment, the present disclosure provides a method of making an abrasive article according to any one of the first through fourteenth embodiments, wherein the backing substrate is a disc.

In a seventeenth embodiment, the present disclosure provides a tooling apparatus for making an abrasive article, the tooling apparatus comprising:

a carrier member having a dispensing surface and a back surface opposite the dispensing surface, wherein the carrier member has cavities formed therein, wherein the cavities extend into the carrier member from the dispensing surface toward the back surface; and
shaped abrasive particles removably and at least partially disposed within at least some of the cavities, wherein at least one of the cavities is configured to allow for multiple orientations of at least one of the shaped abrasive particles.

In an eighteenth embodiment, the present disclosure provides a tooling apparatus for making an abrasive article according to the seventeenth embodiment, further comprising a vacuum source configured to hold at least some of the shaped abrasive particles at least partially in the cavities, prior to transferring the shaped abrasive articles to a backing substrate containing a layer of adhesive.

In a nineteenth embodiment, the present disclosure provides a tooling apparatus for making an abrasive article according to any one of the seventeenth and eighteenth embodiments, wherein at least one of the cavities includes a cross shape.

In a twentieth embodiment, the present disclosure provides a tooling apparatus for making an abrasive article according to any one of the seventeenth through nineteenth embodiments, wherein at least one of the cavities includes an asterisk shape.

In a twenty-first embodiment, the present disclosure provides a tooling apparatus for making an abrasive article according to any one of the seventeenth through twentieth embodiments, wherein at least one of the cavities includes a cone shape.

In a twenty-second embodiment, the present disclosure provides a tooling apparatus for making an abrasive article according to any one of the seventeenth through twenty-first embodiments, wherein at least some of the shaped abrasive particles comprise a ceramic material.

In a twenty-third embodiment, the present disclosure provides a tooling apparatus for making an abrasive article according to any one of the seventeenth through twenty-second embodiments, wherein at least some of the shaped abrasive particles comprise alpha alumina, sol-gel derived alpha alumina, or a mixture thereof.

In a twenty-fourth embodiment, the present disclosure provides a tooling apparatus for making an abrasive article according to any one of the seventeenth through twenty-third embodiments, wherein at least some of the shaped abrasive particles comprise an aluminosilicate, an alumina, a silica, a silicon nitride, a carbon, a glass, a metal, an alumina-phosphorous pentoxide, an alumina-boria-silica, a zirconia, a zirconia-alumina, a zirconia-silica, a fused aluminum oxide, a heat-treated aluminum oxide, a ceramic aluminum oxide, a sintered aluminum oxide, a silicon carbide material, titanium diboride, boron carbide, tungsten carbide, titanium carbide, diamond, cubic boron nitride, gamet, fused alumina-zirconia, cerium oxide, zirconium oxide, titanium oxide, or a combination thereof.

In a twenty-fifth embodiment, the present disclosure provides a tooling apparatus for making an abrasive article according to any one of the seventeenth through twenty-fourth embodiments, wherein at least one of the shaped abrasive particles comprises at least one shape feature comprising: an opening, a concave surface, a convex surface, a groove, a ridge, a fractured surface, a low roundness factor, or a perimeter comprising one or more corner points having a sharp tip.

In a twenty-sixth embodiment, the present disclosure provides a tooling apparatus for making an abrasive article according to any one of the seventeenth through twenty-fifth embodiments, wherein the carrier member comprises a flexible polymer.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

1. A method of making an abrasive article, the method comprising:
aligning a plurality of shaped abrasive particles into a pattern, including collecting the plurality of shaped abrasive particles at least partially into cavities arranged on a dispensing surface, wherein at least one of the cavities is configured to allow for multiple orientations of one of the plurality of shaped abrasive particles;
transferring the pattern to a backing substrate containing a layer of adhesive; and
curing the adhesive.

2. The method of claim 1, wherein each of the cavities is configured to collect a single particle of the plurality of shaped abrasive particles.

3. The method of claim 1, wherein the at least one of the cavities holds a protruding tip of the one of the shaped abrasive particles is in substantially the same position in each of the multiple orientations.

4. The method claim 1, further comprising holding the plurality of shaped abrasive particles at least partially in the cavities using a vacuum source, prior to transferring the pattern to the backing substrate.

5. The method of claim 1, wherein the at least one of the cavities allows for exactly two orientations of the multiple orientations of the one of the plurality of shaped abrasive particles.

6. The method of claim 5, wherein the at least one of the cavities includes a cross shape.

7. The method of claim 5 wherein the at least one of the cavities includes a square shape.

8. The method of claim 1, wherein the at least one of the cavities allows for 3 to 8 orientations of the multiple orientations of the one of the plurality of shaped abrasive particles.

9. The method of claim 8, wherein the at least one of the cavities includes an asterisk shape.

10. The method of claim 1, wherein the at least one of the cavities allows for more than 8 orientations of the multiple orientations of the one of the plurality of shaped abrasive particles.

11. The method of claim 1, wherein the at least one of the cavities allows for any z-direction orientation of the multiple orientations of the one of the plurality of shaped abrasive particles.

12. The method of claim 10, wherein the at least one of the cavities includes a cone shape.

13-16. (canceled)

17. A tooling apparatus for making an abrasive article, the tooling apparatus comprising:
a carrier member having a dispensing surface and a back surface opposite the dispensing surface, wherein the carrier member has cavities formed therein, wherein the cavities extend into the carrier member from the dispensing surface toward the back surface; and
shaped abrasive particles removably and at least partially disposed within at least some of the cavities, wherein at least one of the cavities is configured to allow for multiple orientations of at least one of the shaped abrasive particles.

18. The tooling apparatus of claim 17, further comprising a vacuum source configured to hold at least some of the shaped abrasive particles at least partially in the cavities, prior to transferring the shaped abrasive articles to a backing substrate containing a layer of adhesive.

19. The tooling apparatus of claim 17, wherein at least one of the cavities includes a cross shape.

20. The tooling apparatus of claim 17, wherein at least one of the cavities includes an asterisk shape.

21. The tooling apparatus of claim 17, wherein at least one of the cavities includes a cone shape.

22-24. (canceled)

25. The tooling apparatus of claim 17, wherein at least one of the shaped abrasive particles comprises at least one shape feature comprising: an opening, a concave surface, a convex surface, a groove, a ridge, a fractured surface, a low roundness factor, or a perimeter comprising one or more corner points having a sharp tip.

26. The tooling apparatus of claim 17, wherein the carrier member comprises a flexible polymer.
